(19) United States
(12) Patent Application Publication
(10) Pub. No.: US 2025/0354838 A1
(43) Pub. Date: Nov. 20, 2025

(54) CABLE LAYOUT DETECTION FOR SUBSEA CABLES BY DISTRIBUTED ACOUSTIC SENSING FOR OFFSHORE WIND FARMS

(71) Applicant: NEC Laboratories America, Inc., Princeton, NJ (US)

(72) Inventors: Sarper OZHARAR, Pennington, NJ (US); Wataru KOHNO, Princeton, NJ (US); Yue TIAN, Princeton, NJ (US); Ting WANG, West Windsor, NJ (US); Yangmin DING, East Brunswick, NJ (US)

(73) Assignee: NEC Laboratories America, Inc., Princeton, NJ (US)

(21) Appl. No.: 19/209,321

(22) Filed: May 15, 2025

Related U.S. Application Data
(60) Provisional application No. 63/648,762, filed on May 17, 2024.

(51) Int. Cl. G01D 5/353; G01H 9/00

(52) U.S. Cl. CPC G01D 5/35358; G01H 9/004

(57) ABSTRACT

Disclosed are systems and methods employing distributed fiber optic sensing (DFOS)/distributed acoustic sensing (DAS) in conjunction with mathematical algorithms, and an optional camera to determine layout of subsea cables. The subsea cables are pressure wave detectors of the DAS system and employ mathematical algorithms which map detected pressure waves to sea waves to determine subsea cable layout. When a subsea cable is installed below the seabed, pressure changes due to the waves on the sea surface are still detected. When DAS data is integrated with an optional camera visual input namely: a relative subsea cable layout may be determined by assuming a uniform planar sea wave propagating through the sea; an absolute cable layout may be determined by considering actual sea wave shape detected by the camera; and wave shapes may be determined based on a known subsea cable layout.

### CROSS REFERENCE TO RELATED APPLICATIONS

This application claims the benefit of U.S. Provisional Patent Application Ser. No. 63/648,762 filed May 17, 2024, the entire contents of each of which is incorporated by reference as if set forth at length herein.

### FIELD OF THE INVENTION

This application relates generally to distributed fiber optic sensing (DFOS) systems, methods, and structures. More particularly, it pertains to improved DFOS/Distributed Acoustic Sensing (DAS) systems and methods that detect cable layouts for subsea cables that are applicable to—for example—offshore wind farms.

### BACKGROUND OF THE INVENTION

As those skilled in the art will understand and appreciate, offshore wind farms are a collection of wind turbines that are electrically connected to a mainland and/or each other via composite, subsea cables to transmit generated electrical power to a distribution network. Oftentimes, these composite subsea cables also include optical fiber cables and are located either below the seabed or on the seabed itself.

As will be understood and appreciated by those skilled in the art, the composite cables may not always be in a direct path from one turbine to another. As a result, the composite cables may be longer than a distance between turbines and may move due to undercurrents existing on the seabed to which they are exposed. As a result, it remains important for planning or repair purposes to know exact layouts of these composite cables.

### SUMMARY OF THE INVENTION

An advance in the art is made according to aspects of the present disclosure directed to systems and methods that employ distributed fiber optic sensing (DFOS)/distributed acoustic sensing (DAS) in conjunction with specific mathematical algorithms, and an optional camera to determine the relative or absolute layout of subsea cables.

Viewed from one aspect, our inventive systems and methods use subsea cables as pressure wave detectors as part of a DAS system and employ mathematical algorithms which map detected pressure waves to sea waves to determine fiber layout. Advantageously, even when a subsea cable is installed below the seabed, pressure changes due to the waves on the sea surface are still detected by our inventive systems and methods.

Further features and advantages of systems and methods according to aspects of the present disclosure when DAS data is integrated with an optional camera visual input namely: a relative subsea cable layout may be determined by assuming a uniform planar sea wave propagating through the sea; an absolute cable layout may be determined by considering actual sea wave shape detected by the camera; and wave shapes may be determined based on a known subsea cable layout.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative cable layout of an offshore windfarm and monitoring system according to aspects of the present disclosure.

FIG. 3 is a schematic diagram showing illustrative top view of the cable layout of the windfarm in FIG. 2 according to aspects of the present disclosure.

FIG. 4 is a flow diagram showing illustrative operational aspects of systems and methods according to aspects of the present disclosure.

FIG. 5 is a plot showing illustrative sea waves and subsea cable layout according to aspects of the present disclosure.

FIG. 6 is a plot showing illustrative simulated DAS data and how sea waves and cable layout are detected by a DAS system according to aspects of the present disclosure.

FIG. 7 is a plot showing illustrative pressure wave signal at two points according to aspects of the present disclosure.

FIG. 8 is a plot showing illustrative pressure wave signals spatial measurement of DAS data at an instance according to aspects of the present disclosure.

FIG. 9 is a plot showing illustrative circular sea waves and its detection by cable layout according to aspects of the present disclosure.

FIG. 10 is a schematic diagram showing illustrative features of systems and methods according to aspects of the present disclosure.

FIG. 11 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

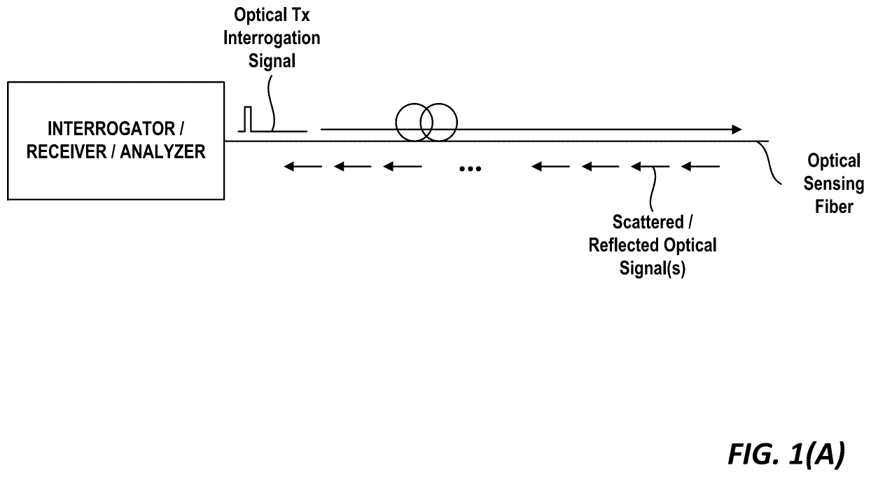

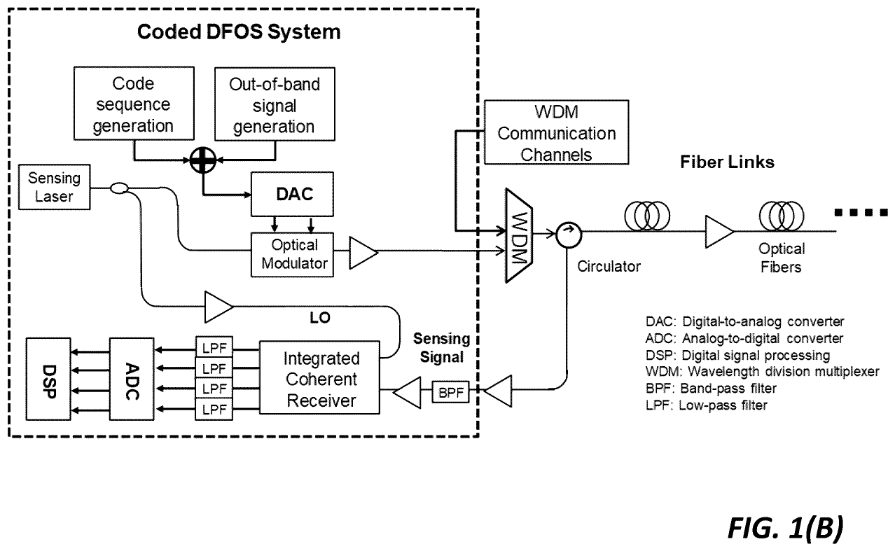

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

We note once again that in offshore wind farms, the wind turbines are connected to the mainland and/or each other via composite cables to transmit generated electrical power to an electrical distribution network. These subsea cables also employ fiber cables (composite cables). These subsea composite cables are either below the seabed or on the seabed and through scouring effects the subsea composite cables may be exposed to the sea water as well.

As those skilled in the art will understand and appreciate, the subsea composite cables may not always lie in a direct path from one turbine to another. Additionally, the subsea composite cables may be longer than the actual straight-line distance between turbines and may move on the seabed due to the undercurrents. As a result, for planning and maintenance purposes it remains critically important to know the actual layout of these subsea composite cables.

In summary, subsea composite cable layouts may be unknown post installation and layouts may change over time.

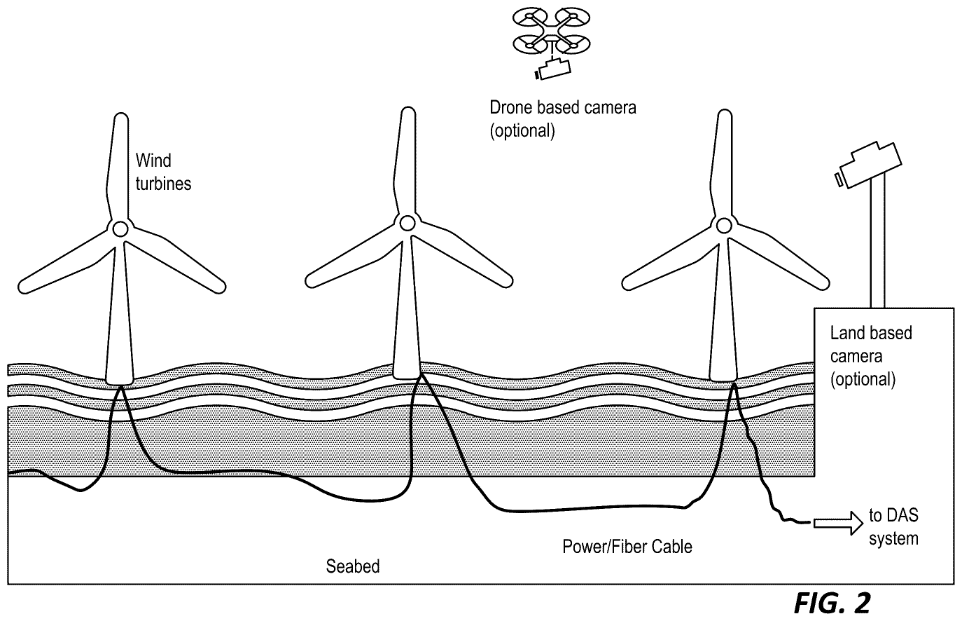

FIG. 2 is a schematic diagram showing an illustrative cable layout of an offshore windfarm and monitoring system according to aspects of the present disclosure.

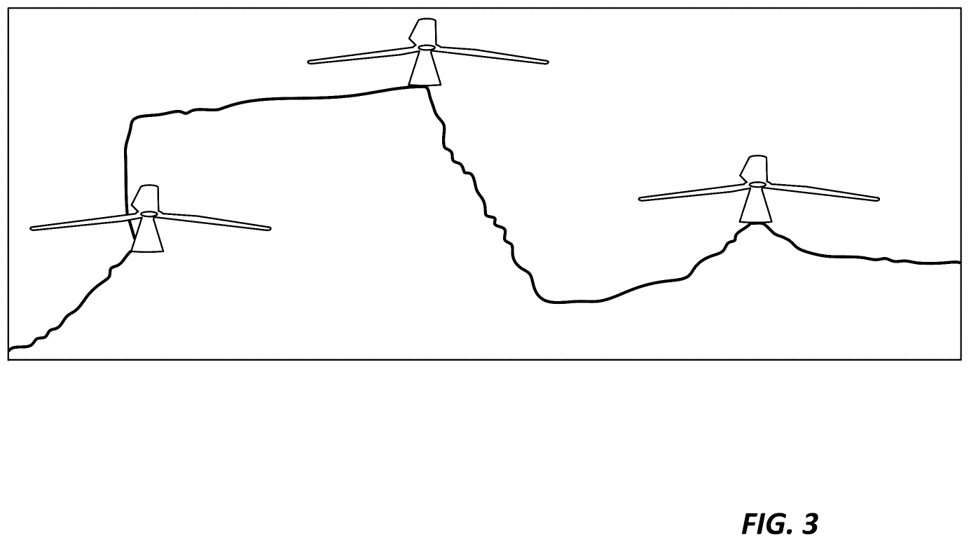

FIG. 3 is a schematic diagram showing illustrative top view of the cable layout of the windfarm in FIG. 2 according to aspects of the present disclosure.

As those skilled in the art will understand and appreciate, our inventive systems and methods combine distributed acoustic sensing (DAS), a mathematical algorithm, and an optional camera to determine the relative (or absolute) layout of the subsea cables.

Importantly, even when a subsea cable is installed below the seabed, our systems and methods detect pressure changes due to the waves on the sea surface, and determines the layout of subsea composite optical fiber cables by measuring how waves on the surface of the sea surface are detected by the DAS system.

We note further that one can assume uniform waves, or our inventive systems and methods can employ a camera that visually observes the surface waves and incorporate aspects of the observed waves into a subsea composite cable layout determination

We additionally note that the relationship between surface waves and the pressure waves detected by the DAS is not straightforward and needs expertise in the DAS principles. Consequently, our inventive systems and methods may be viewed as an algorithmic determination of subsea composite cable layout (i.e. DFOS sensor layout) based on the signal source (sea waves) and the detected pressure waves.

Advantageously, our inventive systems and methods include: a distributed acoustic sensing system undergoing an external excitation (i.e. sea waves or any large), an optional camera for visual confirmation of the actual wave form, and a novel algorithm that determines subsea composite cable layout based on DAS data and (if used) the camera data.

We note at this point that the subsea composite cable as that is used herein, includes one or more optical fibers that act as a DFOS sensor optical fiber providing DVS data along its length during operation of the DFOS system.

Advantageously, our inventive systems and methods according to aspects of the present disclosure detect and determine relative layout of each subsea composite cable segment between turbines and/or the mainland and the absolute layout of the entire subsea composite cable network (if one point along the cable layout is known, for example the starting point).

Our inventive systems and methods according to aspects of the present disclosure also localize subsea composite cables by exciting them with a known submerged pressure source that generates circular waves. When the pressure source is immediately above the subsea composite cable, the detected waveform on a DAS waterfall is linear and indicative of composite cable location.

Accordingly, one inventive aspect of systems and methods according to aspects of the present disclosure involves the use of subsea composite cables as pressure wave detectors by a DAS system, and employing an algorithm that can map these detected pressure waves to the actual sea waves to calculate the subsea composite cable-including optical DAS sensor fiber-layout.

Yet another aspect of systems and methods according to aspects of the present disclosure include an optional integration of a camera's visual input used in combination with the DAS data. When so configured, our inventive systems and methods according to aspects of the present disclosure can determine relative subsea composite cable layout by assuming a uniform planar sea wave propagating along the sea, determine an absolute subsea composite cable layout by using the actual sea wave shape detected by the camera that overlooks an area of interest, and work backwards and determine wave shape based on the known subsea composite cable-including DFOS sensor fiber-layout as well.

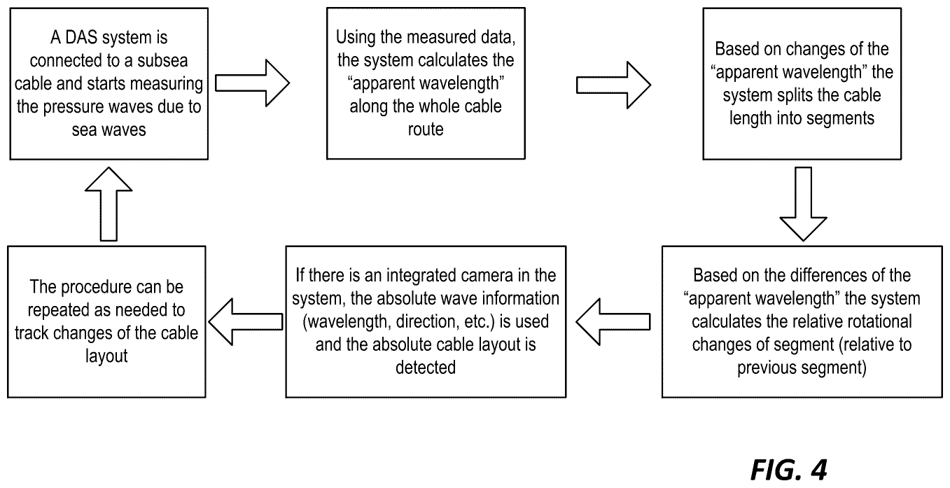

FIG. 4 is a flow diagram showing illustrative operational aspects of systems and methods according to aspects of the present disclosure.

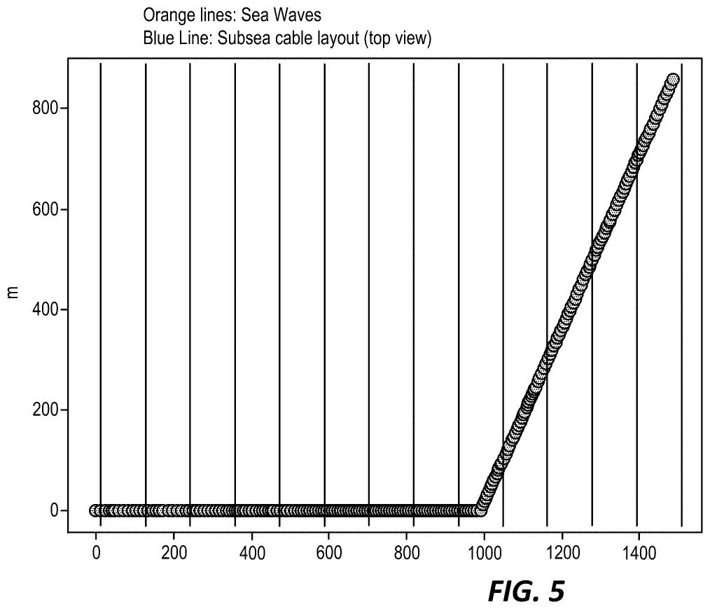

FIG. 5 is a plot showing illustrative sea waves and subsea cable layout according to aspects of the present disclosure. This plot shows is for an illustrative subsea cable layout, wherein total cable length is 2000 meters, the first 1000 meters are situated perpendicular to sea waves, and the second 1000 meters has a deviation of 60 degrees from the previous segment. The figure also shows the propagating sea waves as parallel lines.

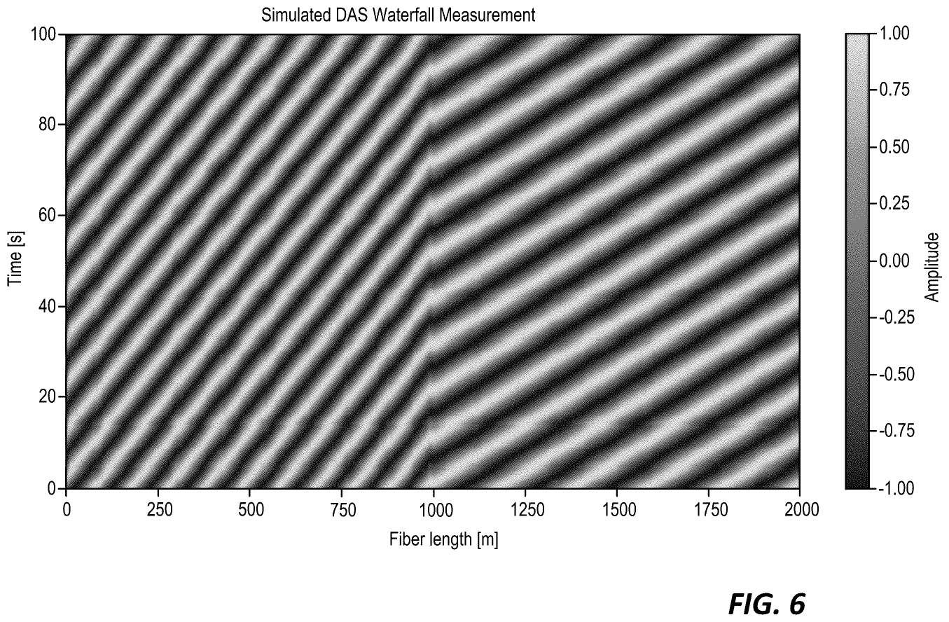

FIG. 6 is a plot showing illustrative simulated DAS data and how sea waves and cable layout are detected by a DAS system according to aspects of the present disclosure.

As seen in this figure, even though the sea waves are perpendicular to the fiber in the first 1000 meter (first segment) the waterfall data show lines at 45 degrees, and in the second segment (second 1000 meters), where the waves are traveling at an angle, the angle in the waterfall does not match the incident angles. That is where the complication resides, and there is not a unique mapping.

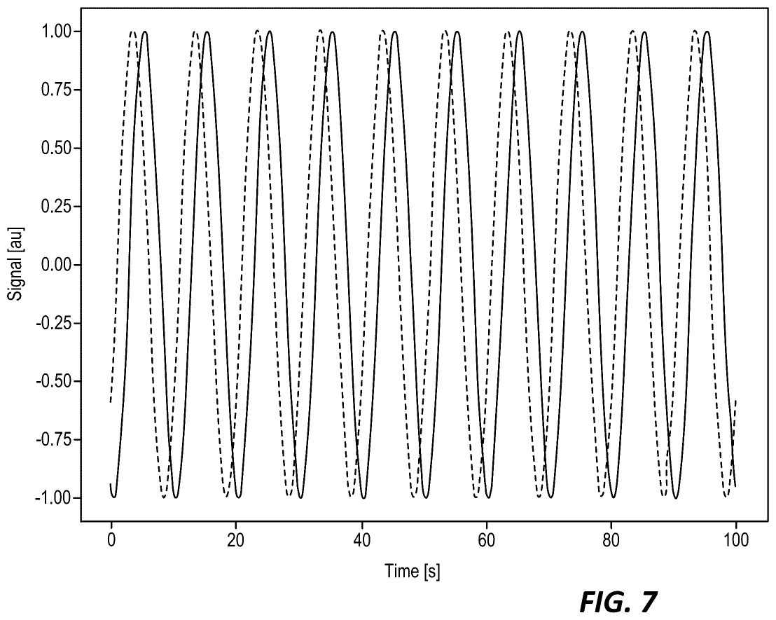

Our innovative systems and methods advantageously consider temporal properties of the wave such as its frequency will be measured same at every point along the fiber cables. However, when looking at the spatial measurements, in other words the DAS data at an instance, it will reveal that the spatial properties of the wave are measured differently depending on the orientation of the subsea composite cable relative to the sea waves. As such, the following FIG. 7 shows the detected pressure wave signal at only two points (each from a different segment.

FIG. 7 is a plot showing illustrative pressure wave signal at two points according to aspects of the present disclosure. As shown in this figure, both points measure the same wave frequency. As seen in this figure, both points measure the same wave frequency.

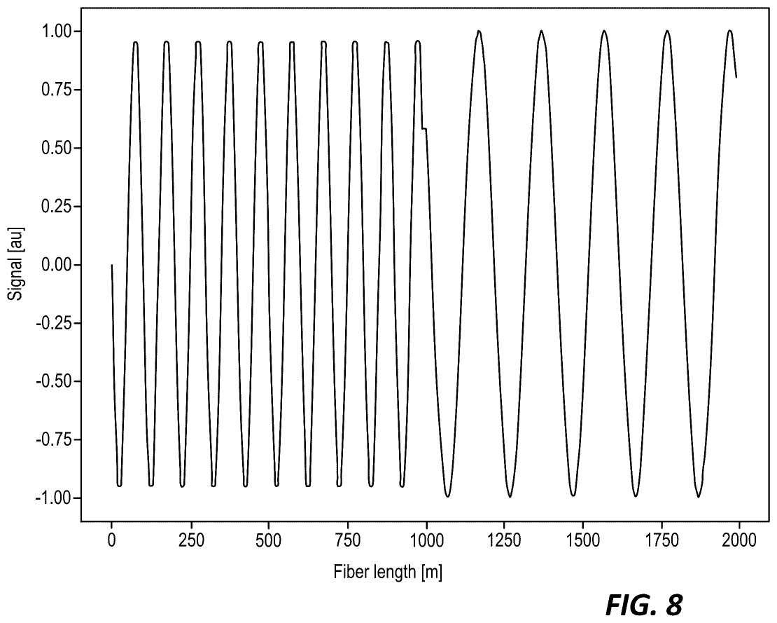

FIG. 8 is a plot showing illustrative pressure wave signals spatial measurement of DAS data at an instance according to aspects of the present disclosure.

As shown illustratively in FIG. 8, both segments measure a different wavelength for the sea wave. However, we assume (or confirm with a camera) that the sea wave has a uniform wavelength. So the if the subsea cable were all linear, DAS would measure the same sea wavelength along the route, however, we can clearly see that the measured wavelength is different after location 1000 m, this means that there is a change on the cables angle.

An analysis of the different measured wavelengths in the different segments will reveal how much rotation one segment has relative to the other, hence the relative cable layout can be determined. However, if one uses a camera and measures the true sea wavelength, then the actual cable layout relative to the sea waves can be calculated.

Of course, there will still be some ambiguity regarding the actual layout since a negative rotation of the cable segment will produce the same results. Hence, the system may require certain points along the way such as the beginning and end points of the cable layout.

Another example, to demonstrate the complexity of the problem, can be given as the case for a circular sea wave and its detection by the cable layout.

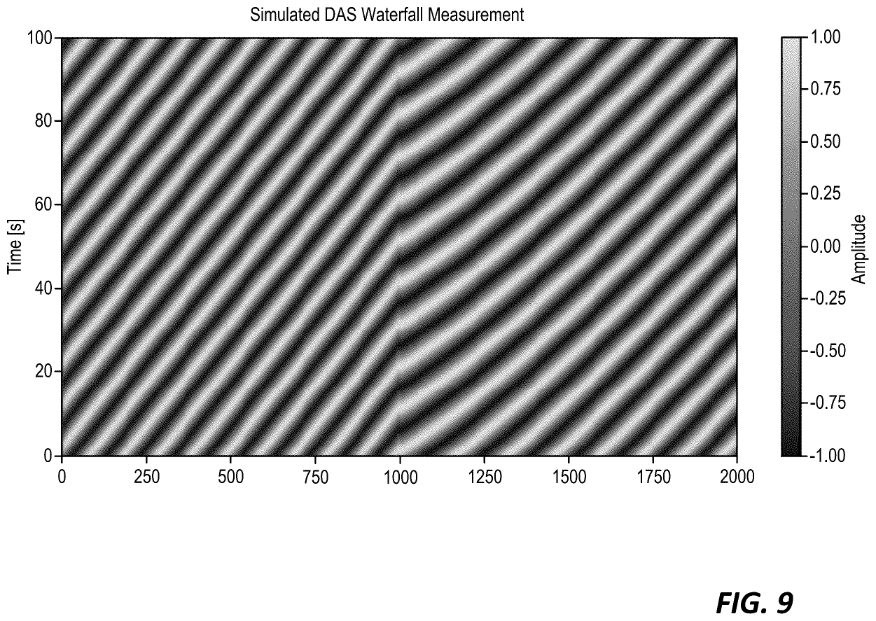

FIG. 9 is a plot showing illustrative circular sea waves and its detection by cable layout according to aspects of the present disclosure.

This figure shows how the same cable layout will detect a circular wave pattern originated at the (0,0) point. In this case, a first segment is not affected the by circular wave, since it originated along its axis. However, a second segment shows nonlinear lines, which are due to either the wave being circular or the fiber being circular. All these ambiguities can be resolved by the use of an external cameras wave measurements.

To summarize, our inventive systems and methods according to aspects of the present disclosure employ DAS measurements of sea surface waves and determines subsea cable layout based on either assumptions about the sea wave, or an external camera and uses the actual sea wave shapes.

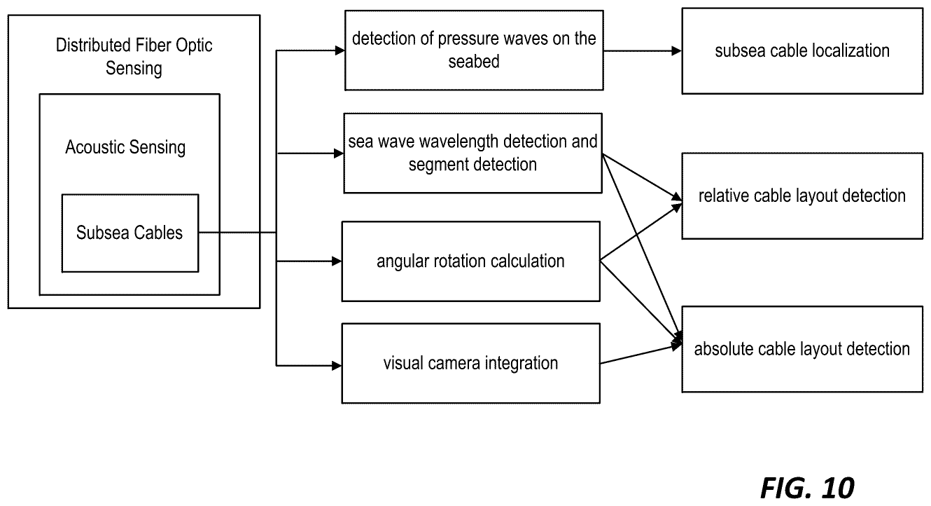

FIG. 10 is a schematic diagram showing illustrative features of systems and methods according to aspects of the present disclosure.

As may be understood from this figure, the following procedures may be used by systems and methods according to aspects of the present disclosure.

Distributed acoustic sensing (DAS) measurements are taken of the sea surface waves using the subsea cables as DAS sensor cables.

DAS waterfall data is split into different segments based on the measured wave properties, based on the measured sea wave's wavelength.

Relative changes of the wavelengths for each segment is used to determine the relative rotation of each segment.

If absolute sea wave data is available via a camera, then it is used to determine the absolute rotation of each segment.

The system may also use external pressure sources to excite the cables in case of weak or no sea waves.

These measurements can be done periodically to determine if there is a change in the subsea cable layout due to undercurrents or other external influences.

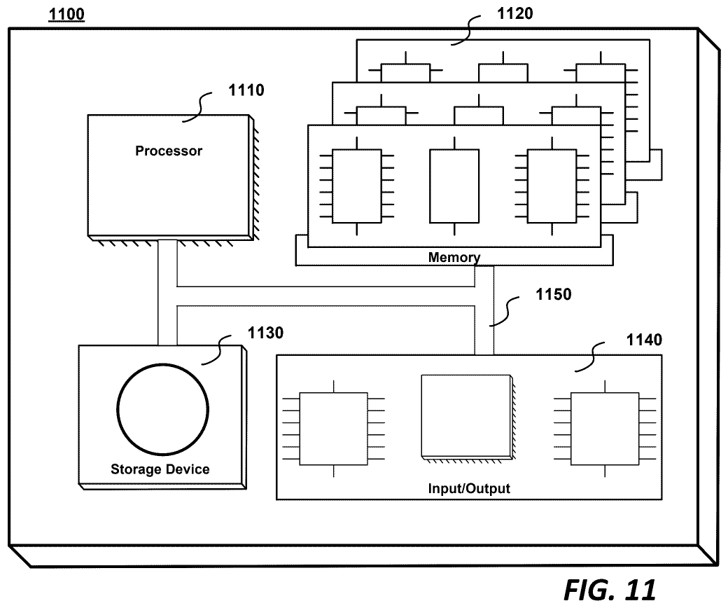

FIG. 11 is a schematic block diagram of an illustrative computer system in which aspects of the present disclosure may be executed to produce methods/algorithms according to aspects of the present disclosure.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 1100 as stored program control instructions.

Computer system 1100 includes processor 1110, memory 1120, storage device 1130, and input/output structure 1140. One or more input/output devices may include a display 11411. One or more busses 11110 typically interconnect the components, 1110, 1120, 1130, and 1140. Processor 1110 may be a single or multi core. Additionally, the system may include accelerators etc., further comprising the system on a chip.

Processor 1110 executes instructions in which embodiments of the present disclosure may comprise steps described in one or more of the Drawing figures. Such instructions may be stored in memory 1120 or storage device 1130. Data and/or information may be received and output using one or more input/output devices.

Memory 1120 may store data and may be a computer-readable medium, such as volatile or non-volatile memory. Storage device 1130 may provide storage for system 1100 including for example, the previously described methods. In various aspects, storage device 1130 may be a flash memory device, a disk drive, an optical disk device, or a tape device employing magnetic, optical, or other recording technologies.

Input/output structures 1140 may provide input/output operations for system 1100.

While we have presented our inventive concepts and description using specific examples, our invention is not so limited. Accordingly, the scope of our invention should be considered in view of the following claims.

1. A computer-implemented method for determining subsea cable layout by distributed acoustic sensing, the method comprising:
collecting distributed acoustic sensing (DAS) data from the subsea cable; and
determining a layout of the subsea cable using the DAS data collected.

2. The method of claim 1 further comprising generating waterfall plots from the collected DAS data, wherein the layout determination of the subsea cable is made using the waterfall plots.

3. The method of claim 2 further comprising splitting waterfall data into different segments from measured wave properties.

4. The method of claim 3 wherein the measured wave properties include measured sea wave wavelength.

5. The method of claim 4 further comprising applying external pressures such that the DAS data collected results from the applied external pressures.

6. The method of claim 5 further comprising determining a relative rotation of each of the different segments.

7. The method of claim 6 further comprising periodically determining the layout of the subsea cable using the DAS data and determining whether the subsea cable is moved due to undercurrents or other external forces.
